(19) United States
(12) Patent Application Publication
(10) Pub. No.: US 2025/0377615 A1
(43) Pub. Date: Dec. 11, 2025

(54) IMAGE FORMING APPARATUS

(71) Applicant: CANON KABUSHIKI KAISHA, Tokyo (JP)

(72) Inventor: KAZUHIRO DODA, Kanagawa (JP)

(21) Appl. No.: 19/221,716

(22) Filed: May 29, 2025

(30) Foreign Application Priority Data
Jun. 6, 2024 (JP) 2024-092489

(51) Int. Cl. G03G 15/20; G03G 15/00

(52) U.S. Cl. CPC G03G 15/205; G03G 15/2053; G03G 15/2064; G03G 15/5029; G03G 15/6529; G03G 15/80; G03G 2215/00734

(57) ABSTRACT

An image forming apparatus includes a fixing device and a controller. When a job in which the image is printed on a narrow sheet is a first printing job, a job which the image is printed on a wide sheet is a second printing job, a time when cooling of a heater of the fixing device is executed after the first printing job is ended is a cooling time, and a time obtained by summing the cooling time and a print completion time is a total time, the controller executes the first printing job by an operation in a printing mode in which the total time becomes shorter between a total time when the controller executes the first printing job by the operation in the first printing mode and a total time when the controller executes the first printing job by the operation in the second printing mode.

### BACKGROUND

### Field of the Technology

The present disclosure relates to an image forming apparatus.

### Description of the Related Art

In an image forming apparatus, such as a copying machine or a printer, in which an electrophotographic type is used, a fixing device in which a toner image transferred on a sheet is heated and fixed on the sheet have been widely used. In the fixing device, a fixing film, a pressing roller, and a heater are used. In such a fixing device, the fixing film and the pressing roller are contacted under pressure, and then the fixing film and the pressing roller are heated by the heater. Then, the sheet is passed through a region where the fixing film and the pressing roller are in contact with each other (hereinafter, this region is referred to as a fixing nip), so that the toner image is fixed on the sheet.

In the image forming apparatus, with respect to a direction perpendicular to a conveying direction of the sheet (hereinafter, this direction is referred to as a longitudinal direction), sheets each having a width narrower than a width of a heat generating element are subjected to continuous printing in some instances. In this case, in the fixing device, the sheet cannot take heat from the fixing film and the pressing roller in a region through which the sheet does not pass (hereinafter, this region is referred to as a non-sheet passing portion or a non-sheet passing (portion region), so that in the non-sheet passing region, the heat is continuously accumulated in the fixing film and the pressing roller. That is, in the non-sheet passing region, the fixing film and the pressing roller reach a high temperature in some instances. By this, there is a liability that parts, constituting the fixing device, such as the fixing film and the pressing roller have an influence of the heat. Further, in the case where a wide-width sheet is passed immediately after the non-sheet passing portion reaches a high temperature by sheet passing of the narrow-width sheet, a phenomenon which is called a hot offset occurs in some cases.

According to Japanese Laid-Open Patent Application No. 2001-282036, in the case where a detection result of a temperature detecting means for detecting a temperature of a non-sheet passing region exceeds a predetermined threshold, and subsequently, a print (printing) job for a wide-width sheet is executed, a cooling time of a fixing device is set. An occurrence of the hot offset can be suppressed since after the non-sheet passing portion (region) is sufficiently cooled, a subsequent printing job is executed. Further, for example, United States Patent Application Publication No. US2022/0308509 discloses a fixing device including a plurality of heat generating elements different in length in a longitudinal direction. From an integrated electric power amount of electric power supplied to each of the heat generating elements, a non-sheet passing portion temperature rise value is estimated, and a cooling time of the fixing device is set longer with a higher one of the temperature rise value. In addition, when narrow-width sheets are passed through the fixing device, two types of the heat generating elements consisting of a long heat generating element and a short heat generating element in length in the longitudinal direction are alternately used. After a start of sheet passing in which the fixing device is cool, a use frequency of the long heat generating element in length in the longitudinal direction is high, so that the number of passing sheets increases. When the fixing device is gradually warmed, a use frequency of the short heat generating element in length in the longitudinal direction is made high. In the case where the use frequency of the long heat generating element in length in the longitudinal direction is high, it is possible to predict that the non-sheet passing portion reaches a high temperature, so that the cooling time is long. On the other hand, in the case where the use frequency of the long heat generating element in length in the longitudinal direction is high, it is possible to predict that the non-sheet passing portion does not reach the high temperature, so that the cooling time is short.

### SUMMARY

The present disclosure has been accomplished in view of the above-described circumstances and is directed to shorten a time until printing of images on a narrow-width sheet and a wide-width sheet is completed in the case where the images are printed on the narrow-width sheet and subsequently on the wide-width sheet.

According to an aspect of the present disclosure, there is provided an image forming apparatus comprising: a fixing device including a heater and for heating a toner image, carried on a recording material, by the heater; and a controller configured to perform control in which an image is printed on the recording material by an operation in a first printing mode for performing image formation while conveying the recording material at a first conveying speed or in which the image is printed on the recording material by an operation in a second printing mode for performing the image formation while conveying the recording material at a second conveying speed slower than the first conveying speed, wherein when a length of the recording material in a direction perpendicular to a conveying direction of the recording material is a width, a job in which the image is printed on a first sheet having a first width as the width is a first printing job, a job which the image is printed on a second sheet having a second width wider than the first width and conveyed subsequently to the first sheet is a second printing job, a time in which cooling of the heater is executed after the first printing job is ended is a cooling time, and a time obtained by summing the cooling time and a print completion time from a start of printing of the first printing job to completion thereof is a total time, the controller executes the first printing job by an operation in a printing mode in which the total time becomes shorter between a total time when the controller executes the first printing job by the operation in the first printing mode and a total time when the controller executes the first printing job by the operation in the second printing mode.

According to the present disclosure, in the case where the images are printed on the narrow-width sheet and subsequently on the wide-width sheet, the time until the printing of the images on the narrow-width sheet and the wide-width sheet is completed can be shortened.

Features of the present disclosure will become apparent from the following description of embodiments with reference to the attached drawings. The following description of embodiments are described by way of example.

### BRIEF DESCRIPTION OF THE DRAWINGS

FIG. 1 is a whole constitution view of an image forming apparatus according to embodiments 1 and 2.

FIG. 2 is a control block diagram of the image forming apparatus of the embodiments 1 and 2.

FIG. 3 is a schematic sectional view of a fixing device according to the embodiment 1.

FIG. 4 is a relationship diagram between a narrow-width sheet, a heater, and a fixing film with respect to a longitudinal direction in the embodiment 1.

Parts (a) and (b) of FIG. 5 are sectional views for illustrating a hot offset phenomenon in a non-sheet passing (portion) region A in the embodiments 1 and 2.

FIG. 6 is a graph showing a relationship between the number of passing sheets and a cooling time in the embodiment 1.

Parts (a) and (b) of FIG. 7 are schematic views each showing a printing job and a cooling time in the embodiment 1.

Parts (a) and (b) of FIG. 8 are graphs each showing a sheet passing mode and the cooling time in the embodiment 1.

FIG. 9 is a flowchart showing determination of an operation in a printing mode in a first printing job in the embodiments 1 and 2.

FIG. 10 is a graph showing a relationship between the number of passing sheets and a cooling time in the embodiment 1.

Parts (a) and (b) of FIG. 11 are schematic views showing a heater and an electric circuit of the heater, respectively, embodiment 2.

### DESCRIPTION OF THE EMBODIMENTS

In the following, embodiments of the present disclosure will be described specifically with reference to the drawings. Incidentally, in the following description, conveyance of sheet(s) is referred to as sheet passing. With respect to a longitudinal direction (direction perpendicular to a sheet conveying direction) of a heat generating element included in a fixing device, a region in which the sheet is not passed is referred to as a non-sheet passing portion or a non-sheet passing (portion) region. On the other hand, with respect to the longitudinal direction, a region in which the sheet is passed is referred to as a sheet passing portion or a sheet passing region. A phenomenon such that a temperature becomes high in the non-sheet passing region compared with the sheet passing region is referred to as non-sheet passing portion temperature rise. Further, as regards, the heat generating element included in the heater, an operation in which heat is generated by passing a current through the heat generating element under control of a circuit for passing the current through the heat generating element by a CPU is expressed that the heat generating element is used in some instances. In addition, when the heater includes a plurality of heat generating elements, an operation in which a heat generating element through which the current passes is switched by switching a current passing path on a circuit under control by the CPU (hereinafter, this path is also referred to as an electrical conduction path) is simply expressed that the heat generating element is switched in some instances. Further, the printing job means a single print (printing) instruction using a personal computer by a user.

### Embodiment 1

### [Image Forming Apparatus]

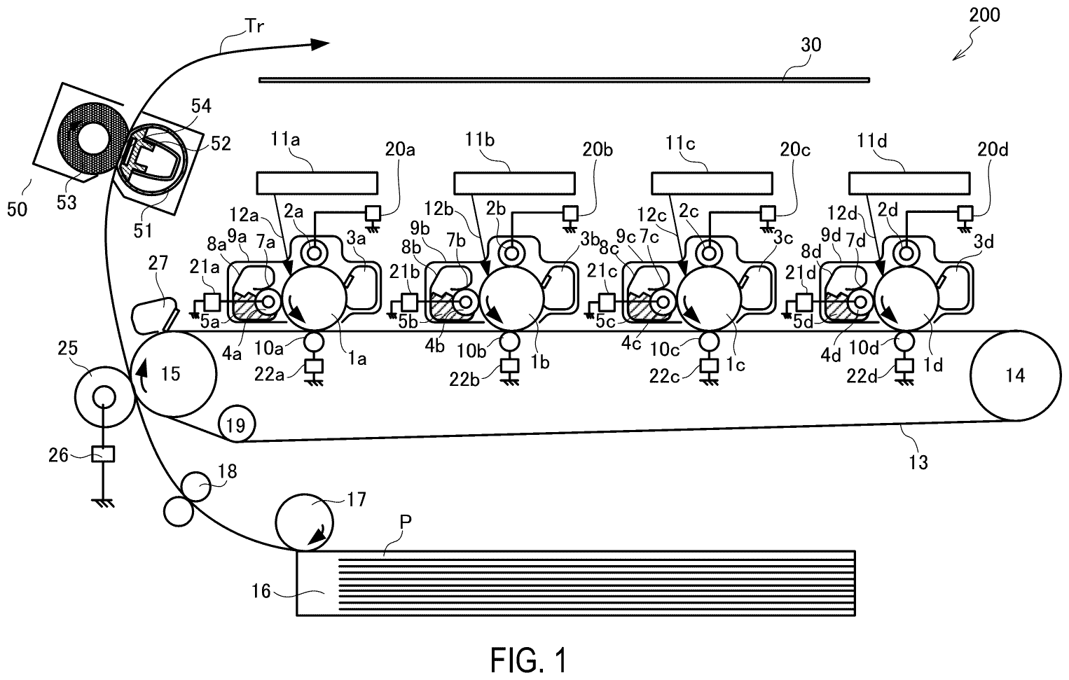

FIG. 1 is a schematic sectional view showing a structure of an in-line color image forming apparatus (hereinafter, simply referred to as an image forming apparatus) 200 which is an example of an image forming apparatus in which a fixing device according to an embodiment 1 is mounted. An operation of the image forming apparatus 200 of an electrophotographic type will be described using FIG. 1. Incidentally, a first station is a station for forming a toner image of yellow (Y), and a second station is a station for forming a toner image of magenta (M). Further, a third station is a station for forming a toner image of cyan (C), and a fourth station is a station for forming a toner image of black (K).

In the first station, a photosensitive drum 1a as an image bearing member is an organic photoconductor (OPC) photosensitive (member) drum. The photosensitive drum 1a comprises a plurality of lamination layers of functional organic materials, including a carrier generating layer for generating electric charges on a metal cylinder through light exposure and a charge transporting layer for transporting the generated electric charges, and the like layer, and an outermost layer which is low in electrical conductivity and which is substantially insulative. A charging roller 2a as a charging means is contacted to the photosensitive drum 1a and electrically charges a surface of the photosensitive drum 1a uniformly while being rotated with rotation of the photosensitive drum 1a. To the charging roller 2a, a voltage superpose d with a DC voltage or an AC voltage is applied, so that electric discharge generates from a nip between the surfaces of the charging roller 2a and the photosensitive drum 1a in minute air gaps on sides upstream and downstream of the nip with respect to a rotational direction of the photosensitive drum 1a, whereby the photosensitive drum 1a is charged. A cleaning unit 3a is a unit for removing toner remaining on the photosensitive drum 1a after transfer described later. A developing unit 8a as a developing means includes a developing roller 4a non-magnetic one-component toner 5a, and a developer application blade 7a. The photosensitive drum 1a, the charging roller 2a, the cleaning unit 3a, and the developing unit 8a constitute an integral process cartridge 9a mountable in and demountable from the image forming apparatus 200.

An exposure device 11a as an exposure means is constituted by a scanner unit or an LED (light emitting diode) array for scanning the photosensitive drum 1a with laser light reflected by a polygonal mirror, and the surface of the photosensitive drum 1a is irradiated with a scanning beam 12a modulated on the basis of an image signal. Further, the charging roller 2a is connected to a charging high-voltage power source 20a as a voltage supplying means to the charging roller 2a. The developing roller 4a is connected to a developing high-voltage power source 21a as a voltage supplying means to the developing roller 4a. A primary transfer roller 10a is connected to a primary transfer high-voltage power source 22a as a voltage supplying means to the primary transfer roller 10a. The above is a constitution of the first station, and the second to fourth stations have similar constitutions. As regards the second to fourth (other) stations, component elements having the same functions as those in the first station are represented by the same reference numerals, and associated suffixes b, c and d are added to the reference numerals for the respective stations. Incidentally, in the following description, the suffixes a, b, c, and d will be omitted except for the case where a specific station is described.

An intermediary transfer belt 13 is supported by three rollers, as stretching members therefor, consisting of a secondary transfer opposite roller 15, a tension roller 14, and an auxiliary roller 19. To only the tension roller 14, a force in a direction in which the intermediary transfer belt 13 is stretched is applied by a spring, so that proper tension applied to the intermediary transfer belt 13 is maintained. The secondary transfer opposite roller 15 is rotated by receiving rotational drive from a main motor (not shown), so that the intermediary transfer belt 13 surrounding an outer periphery of the secondary transfer opposite roller 15 is rotated. The intermediary transfer belt 13 is moved in a forward direction (for example, the clockwise direction in FIG. 1) for the photosensitive drums 1a to 1d (for example, rotate in the counterclockwise direction in FIG. 1) substantially at the same speed. Further, the intermediary transfer belt 13 is rotated in an arrow direction (clockwise direction), and the primary transfer roller 10 is disposed on a side opposite to the photosensitive drum 1 while sandwiching the intermediary transfer belt 13 therebetween, so that the primary transfer roller 10 is rotated with movement of the intermediary transfer belt 13. A position where the photosensitive drum 1 and the primary transfer roller 10 are in contact with each other while sandwiching the intermediary transfer belt 13 therebetween is referred to as a primary transfer position. The auxiliary roller 19, the tension roller 14 and the secondary transfer opposite roller 15 are electrically grounded. Incidentally, primary transfer rollers 10b to 10d of the second to fourth stations also have constitutions similar to the constitution of the primary transfer roller 10a of the first station, and therefore, will be omitted from description.

Next, an image forming operation of the image forming apparatus 200 of the embodiment 1 will be described. When the image forming apparatus 200 receives a print instruction in a stand-by state, the image forming apparatus 200 starts the image forming operation. The photosensitive drum 1 and the intermediary transfer belt 13, and the like start rotations in the arrow directions in FIG. 1 at a predetermined process speed by the main motor (not shown). The photosensitive drum 1a is electrically charged uniformly by the charging roller 2a to which a voltage is applied from the charging high-voltage power source 20a, and then is exposed to the scanning beam 12a emitted from the exposure device 11a, so that an electrostatic latent image in accordance with image information is formed on the photosensitive drum 1a. Toner 5a in the developing unit 8a is negatively charged by the developer applying blade 7a and is applied onto the developing roller 4a. Then, to the developing roller 4a, a predetermined developing voltage is applied from the developing high-voltage power source 21a. The photosensitive drum 1a is rotated, and when the electrostatic latent image formed on the photosensitive drum 1a reaches the developing roller 4a, the electrostatic latent image is visualized by deposition of the negatively charged toner 5a thereon, so that a toner image of a first color (for example, Y (yellow)) is formed in the photosensitive drum 1a. The stations (process cartridges 9b to 9d) for other colors of M (magenta), C (cyan) and K (black) similarly operate. At certain timings, depending on distances between the respective primary transfer positions for the colors, the electrostatic latent images by exposure are formed on the photosensitive drums 1a to 1d while delaying writing signals from a controller (not shown). To each of the primary transfer rollers 10a to 10d, a high DC voltage of a polarity opposite to a charge polarity of the toner 5a is applied. By the above-described steps, the toner images are successively transferred onto the intermediary transfer belt 13 (hereinafter, this transfer is referred to as primary transfer), so that multiple-toner images are formed on the intermediary transfer belt 13.

Thereafter, in synchronism with the toner image formation, a sheet P as a recording material stacked on a cassette 16 is conveyed along a conveying path Tr. Specifically, the sheet P is fed (picked up) by a sheet (paper) feeding roller 17 rotationally driven by a sheet (paper) feeding solenoid (not shown). The fed sheet P is conveyed to a registration roller pair 18 by feeding (conveying) rollers. The sheet P is conveyed to a transfer nip, which is a contact portion between the intermediary transfer belt 13 and a secondary transfer roller 25, by the registration roller pair 18 in synchronism with the toner images on the intermediary transfer belt 13. To the secondary transfer roller 25, a voltage of a polarity opposite to the charge polarity of the toner 5 is applied by a secondary transfer high-voltage power source 26, so that the multiple toner images of the four colors carried on the intermediary transfer belt 13 are collectively transferred onto the sheet (recording material) P (hereinafter, this transfer is referred to as secondary transfer). Members contributing to the image forming operation until the unfixed toner images are formed on the sheet P (for example, the photosensitive drum 1 and the like) function as an image forming means. On the other hand, after the secondary transfer is ended, the toner 5 remaining on the intermediary transfer belt 13 is removed by a cleaning unit 27. The sheet P after the secondary transfer is ended is conveyed toward a fixing device 50 as a fixing means and is subjected to fixing of the toner image, and then is discharged as an image-formed product (print, copy) onto a discharge tray 30. A fixing film 51, a nip-forming member 52, a pressing roller 53, and a heater 54 of the fixing device 50 will be described later.

### [Block Diagram of Image Forming Apparatus]

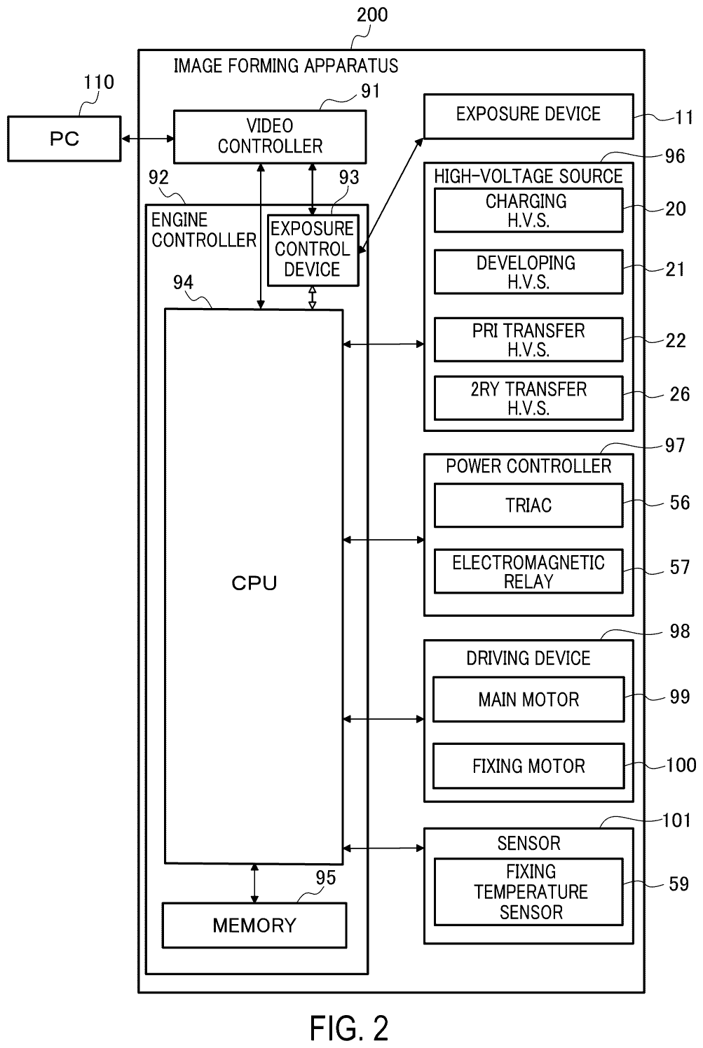

FIG. 2 is a block diagram for illustrating an operation of the image forming apparatus 200, and a printing operation of the image forming apparatus 200 will be described while making reference to FIG. 2. A PC 110 which is a host computer outputs a print (printing) instruction to a video controller 91 provided inside the image forming apparatus 200, and has a function of transferring sheet information, printed sheet number information, and image data of a print image to the video controller 91. The video controller 91 selects a sheet passing mode (print (printing) mode) on the basis of sheet information and notifies the selected sheet passing mode to an engine controller 92.

In conformity to a sheet size designated by PC 110 as a designating means (hereinafter, this size is referred to as a designated sheet size), a size of image data (hereinafter, this size is referred to as an image size) is determined.

Incidentally, a sheet size inputted from an input portion (not shown) provided in the image forming apparatus 200 may be used as the designated sheet size, and in this case, the input portion corresponds to the designating means. In the embodiment 1, a size obtained by subtracting 5 mm for each of sheet side margins, i.e., 10 mm in total for opposite side margins, of the sheet (paper) from the designated sheet size is the sheet size. The video controller 91 converts the image data, from the PC 110, into the exposure data, and transfers the exposure data to an exposure control device 93 provided in the engine controller 92. The exposure control device 93 is controlled from the CPU 94, and performs turning-on and turning-off of the exposure data and control of the exposure device 11. A size of the exposure device is determined by the image size. The CPU 94 as a control means starts an image forming sequence when receives the printing instruction.

In the engine controller 92, the CPU 94, a memory 95 and the like are mounted, and the engine controller 92 performs an operation programmed in advance. A high-voltage power source 96 is constituted by the charging high-voltage power source 20, the developing high-voltage power source 21, the primary transfer high-voltage power source 22, and the secondary transfer high-voltage power source 26 which are described above. Further, an electric power controller 97 is constituted by a bidirectional thyristor (hereinafter, referred to as a triac) 56, and an electromagnetic relay 57 as a switching means for exclusively selecting the heat generating element for supplying the electric power, and the like. The electric power controller 97 selects the heat generating element generating heat in the fixing device 50 and determines an amount of electric power supplied.

A driving device 98 is constituted by the main motor 99, the fixing motor 100, and the like. Further, a sensor 101 is constituted by the fixing temperature sensor 59 for detecting the temperature of the fixing device 50, and the like, and detection result of the sensor 101 is sent to the CPU 94. The CPU 94 acquires the detection result of the sensor 101 in the image forming apparatus 200, and controls the exposure device 11, the high-voltage power source 96, the electric power controller 97, and the driving device 98. By this, the CPU 94 carries out formation of the electrostatic latent image, transfer of the toner image into which the electrostatic latent image is developed, fixing of the toner image on the sheet P, and the like, and thus carries out control of an image forming step in which exposure data is printed as the toner image on the sheet P. Incidentally, the image forming apparatus to which the present disclosure is applied is not limited to the image forming apparatus having a constitution described with reference to FIG. 1, but may only be required to be an image forming apparatus capable of printing images on sheets P different in width and including the fixing device 50 provided with the heater 54 described later.

### [Fixing Device]

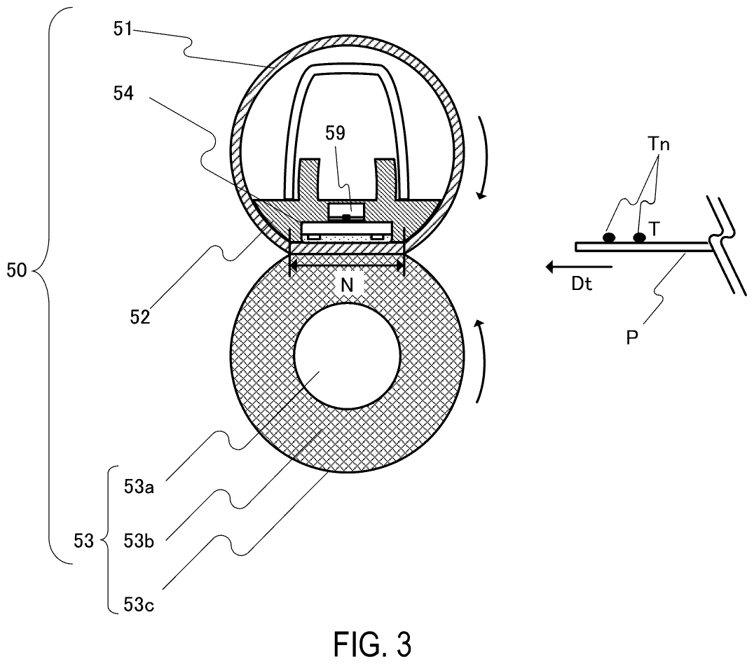

Next, a constitution of the fixing device 50 in the embodiment 1 will be described using a schematic sectional view of the fixing device 50 shown in FIG. 3. Here, the longitudinal direction is a rotational axis direction of the pressing roller 53, described later, substantially perpendicular to the conveying direction of the sheet P. Further, a length of the sheet P in a direction (longitudinal direction) substantially perpendicular to the conveying direction is referred to as a width.

The sheet P holding thereon an unfixed toner image Tn is heated while being conveyed from right to left in FIG. 3 in a fixing nip N. Incidentally, the conveying direction is indicated by an arrow Dt. The fixing device 50 in the embodiment 1 is constituted by the fixing film 51, the nip-forming member 52 for holding the fixing film 51, the pressing roller 53 for forming the fixing nip N in cooperation with the fixing film 51, and the heater 54 for heating the sheet P.

Detailed contents of respective component parts will be described.

### (Fixing Film 51)

The fixing film 51 (film) as a first rotatable member is a cylindrical rotatable member, and is constituted by forming, on a base layer using polyimide as a base material, an elastic layer formed of a silicone rubber and a parting layer, formed of PFA. The fixing film 51 has a cylindrical shape, and is 18 mm in outer diameter and 222 mm in length in the longitudinal direction. A base layer thickness if 60 μm, an elastic layer thickness is 180 μm, and a parting layer thickness is 15 μm.

In order to reduce a frictional force generated between the nip-forming member 52 and the heater 54, and the fixing film 51 is rotation of the fixing film 51, grease is applied onto an inner surface of the fixing film 51.

### (Nip-Forming Member 52)

The nip-forming member 52 performs a function of not only guiding the fixing film 51 from an inside and but also forming the fixing nip N between itself and the pressing roller 53 through the fixing film 51. The nip-forming member 52 is a member having rigidity, a heat-resistant property, and a heat-insulating property, and is formed of a liquid crystal polymer, or the like. The fixing film 51 is externally fitted to the nip-forming member 52.

### (Pressing Roller 53)

The pressing roller 53 as a second rotatable member is a roller as a rotatable pressing member. The pressing roller 53 is constituted by a core metal 53a, an elastic length 53b, and a parting layer 53c. The pressing roller 53 is rotatably held in opposite end portions thereof and is rotationally driven by a fixing motor 100 (see FIG. 2). Further, by rotation of the pressing roller 53, the fixing film 51 is rotated. The heater 54 as a heating member is held by the nip-forming member 52 and contacts the inner surface of the fixing film 51.

An outer diameter of the pressing roller 53 is 18 mm, and an outer diameter of the core metal 53a is 11 mm. Therefore, the elastic layer has a thickness of about 3.5 mm. The parting layer has a thickness of 30 μm.

### (Heater 54)

The heater 54 is provided in an inside space of the fixing film 51. The heater 54 is constituted by a substrate, a heat generating element, an electroconductor, a contact, and protecting glass. The substrate is formed of alumina (Al₂O₃) which is ceramic. As the ceramic substrate, substrates formed of the alumina (Al₂O₃), aluminum nitride (AlN), zirconia (ZrO₂), silicon carbide (SiC), and the like are widely known, and among these, the alumina (Al₂O₃) is in expensive and easily available. Further, as a material of the substrate, metal excellent in strength may be used, and as the metal substrate, a stainless steel (SUS) substrate is excellent in cost and strength and is suitably used. In either one of the ceramic substrate and the metal substrate, in the case where the substrate has electroconductivity, the substrate may be used after being provided with an insulating layer. On the substrate, the heat generating element, the electroconductor, and the contact are formed, and thereon, a protective glass layer is formed in order to ensure insulation between the heat generating element and the fixing film 51.

### (Fixing Temperature Sensor 59)

As the fixing temperature sensor 59 as a temperature detecting means, a thermistor element is used. The fixing temperature sensor 59 is constituted by the thermistor element, the holder, ceramic paper, and an insulating resin sheet. The fixing temperature sensor 59 is contact-disposed on a surface, of the heater 54, opposite from the protective glass, i.e., on the substrate side. The ceramic paper performs function of inhibiting heat conduction between the holder and the thermistor element. The insulating resin sheet performs a function of physically and electrically protecting the thermistor element. The thermistor element is changed in output value depending on a temperature of the heater 54 and is connected to the CPU 94 by Dumet wire (not shown) and wiring. The thermistor element detects the temperature of the heater 54 and outputs a detection result to the CPU 94. The CPU 94 controls the temperature of the heater 54 during fixing processing on the basis of the fixing temperature sensor 59.

[Relationship Between Narrow-Width Sheet, Heater, and Fixing Film Temperature Rise with Respect to Longitudinal Direction]

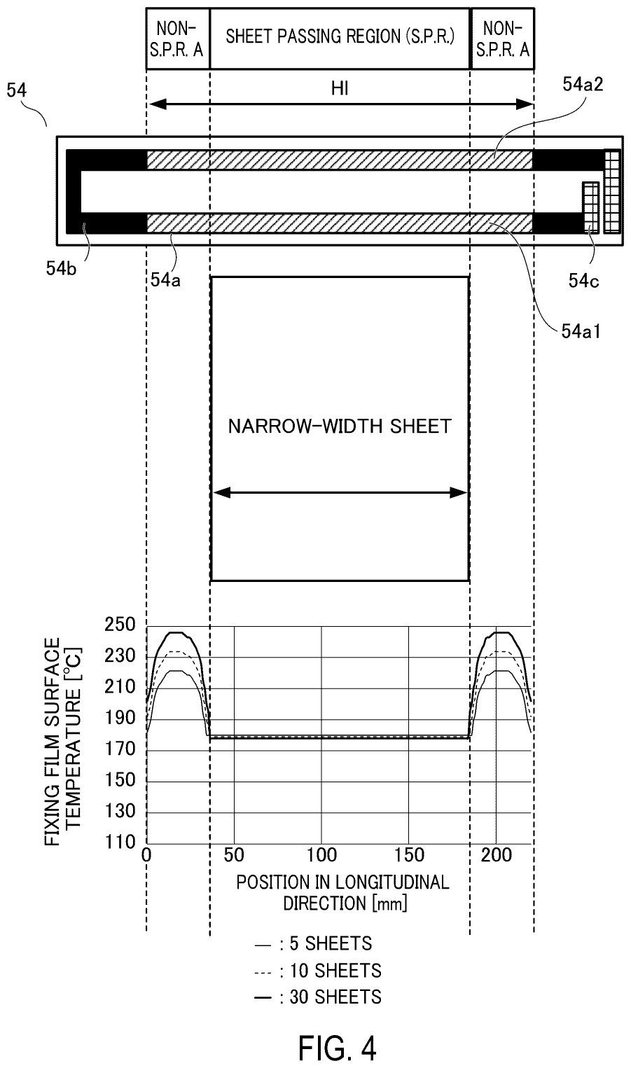

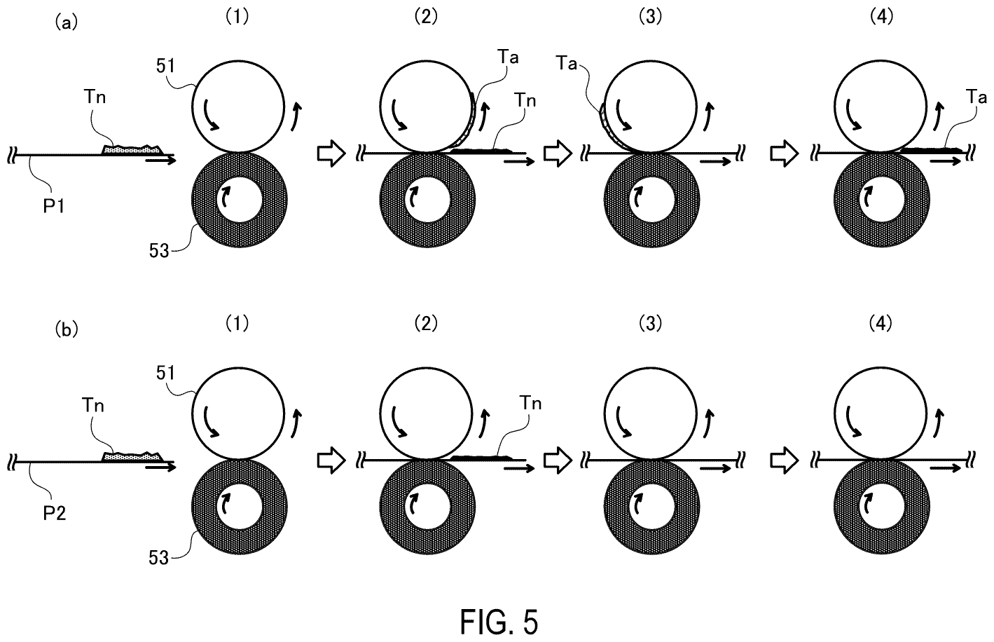

FIG. 4 shows a relationship diagram with respect to the longitudinal direction between the narrow-width sheet (sheet having a narrow width) as a first sheet having a first width, the heater 54, and the temperature rise of the fixing film 51. In FIG. 4, the heater 54 is displayed so that the heat generating element thereof becomes a front side. The heater 54 includes a heat generating element 54a indicated by a hatched line, and a length H1 of the heat generating element 54a in the longitudinal direction is 220 mm. Incidentally, the heat generating element 54a of the heater 54 specifically includes two heat generating elements 54al and 54a2 having the same length H1. The heat generating elements 54al and 54a2 are arranged in the conveying direction (widthwise direction of the heater 54). The heater 54 also includes an electroconductor 54b indicated by black and a contact 54c indicated by lattice. In FIG. 4, a positional relationship between the heater 54 and the narrow-width sheet with respect to the longitudinal direction is also shown. Incidentally, the narrow-width sheet has an A5 size in the image forming apparatus 200 of the embodiment 1 and has a dimension of 148 mm in short side and 210 mm in long side. A region in which the narrow-width sheet passes through the fixing nip N is a sheet passing region, and a region in which the narrow-width sheet does not pass through the fixing nip N is a non-sheet passing (portion) region A. These regions are shown in an upper portion of FIG. 4.

In a lower portion of FIG. 4, a temperature profile of the fixing film 51 with respect to the longitudinal direction when the narrow-width sheet is passed through the fixing device 50 is shown. In this graph, an abscissa represents a position [mm] on the heat generating element 54a with respect to the longitudinal direction, and an ordinate represents a temperature [° C.] of the fixing film 51. Incidentally, the position on the heat generating element 54a is 0 mm at an end portion of the heat generating element 54a remote from the contact 54c in the longitudinal direction and is 220 mm at an end portion of the heat generating element 54a closer to the contact 54c in the longitudinal direction.

The graph in the lower portion of the FIG. 4 is the temperature profile of the fixing film 51 with respect to the longitudinal direction when narrow-width sheets are continuously passed through the fixing device 50 from a cool state by 5 sheets, 10 sheets, and 30 sheets. Incidentally, a plot of continuous passing 5 narrow-width sheets is indicated by a solid line, a plot of continuous passing of 10 narrow-width sheets is indicated by a broken line, and a plot of continuous passing of 30 narrow-width sheets is indicated by a bold (thick) line. A sheet passing condition is as follows. A temperature control value of the fixing device 50 is 220° C., a conveyance speed of the sheet P is 180 mm/sec, and as the A4-size narrow-width sheet, high-quality paper (“GF-C081”, manufactured by CANON KABUSHIKI KAISHA) was used. Sheet passing is repeated with an interval, between a trailing end of a preceding sheet and a leading end of a subsequent sheet, of 40 mm (sheet interval: 40 mm).

In the sheet passing region, the temperature of the heater 54 is controlled by an unshown fixing temperature sensor 59 in FIG. 4 disposed in a central portion of the heater 54 with respect to the longitudinal direction, so that the temperature of the fixing film 51 in the sheet passing region is stabilized at about 180° C. On the other hand, in the non-sheet passing region A, the sheet P does not pass through the fixing device 50, so that heat is gradually accumulated continuously in the non-sheet passing region A and the temperature of the fixing film 51 reaches a high temperature. A maximum temperature of the fixing film 51 in the non-sheet passing region is 220° C. after passing of 5 sheets, 235° C. after passing of 10 sheets, and 245° C. after passing of 30 sheets. With an increasing number of passing sheets, the temperature of the fixing film 51 in the non-sheet passing region becomes high. That is, a non-sheet passing portion temperature rise phenomenon occurs.

Immediately after the non-sheet passing portion temperature rise phenomenon occurs, when passing of a second sheet having a second width (hereinafter, this sheet is referred to as a wide-width sheet) wider than the narrow-width sheet (A4-size sheet in the embodiment 1) is continued, a part of the wide-width sheet passes through the non-sheet passing region A. For this reason, in the non-sheet passing region, there is a possibility that a hot offset phenomenon occurs on the wide-width sheet.

### [Hot Offset]

In FIG. 5, a state of a cross section of the fixing device 50 with a lapse of time in the non-sheet passing region A and the sheet passing region when the wide-width sheet is passed through the fixing device 50 immediately after the narrow-width sheet is passed through the fixing device 50 is shown. The lapse of time in the case where the hot offset occurs in the non-sheet passing region A is shown in part (a) of FIG. 5, and the lapse of time in the case where the hot offset does not occur in the non-sheet passing region A is shown in part (b) of FIG. 5. The time goes on in an order of (1), (2), (3), and (4).

A state of the lapse of time of part (a) of FIG. 5 will be described. In part (a) of FIG. 5, (1) shows a state immediately before a sheet P1 passes through the fixing nip N formed by the fixing film 51 and the pressing roller 53. The unfixed toner image Tn is formed on the sheet P1. (2) shows a state immediately after the toner image Tn on the sheet P1 passes through the fixing nip N. The toner image Tn heated and pressed in the fixing nip N is stuck on the sheet P1. On the other hand, a part Ta of the toner image Tn is deposited on a surface of the fixing film 51. When a surface temperature of the fixing film 51 is excessively high, the toner image Tn is softened, so that the part Ta of the toner image Tn is deposited on not only the sheet P1 but also the surface of the fixing film 51. In the following, the part Ta of the toner image Tn deposited on the fixing film 51 is referred to as a deposited toner image Ta.

In part (a) of FIG. 5, (3) shows a state in which a short time elapses from the state of (2). Specifically, the state of (3) is a state after about one-full circumference (one turn) of the fixing film 51 from a state of (2), and a state immediately before the deposited toner image Ta deposited on the fixing film 51 enters the fixing nip N is shown. (4) shows a state after the deposited toner image Ta enters, together with the sheet P1, the fixing nip N and is stuck on the sheet P1 by being heated and pressed. Such a phenomenon from (1) to (4) is called the hot offset phenomenon.

A state of the lapse of time in part (b) of FIG. 5 will be described. Different from the states shown in part (a) of FIG. 5, the temperature of the fixing film 51 is low, so that the toner image is not deposited on the fixing film 51. That is, in part (b) of FIG. 5, the deposited toner image Ta is not deposited on the fixing film 51. Therefore, the hot offset phenomenon does not occur on a sheet P2.

### [Cooling Time]

In order to suppress the hot offset on the wide-width sheet immediately after the passing of the narrow-width sheet, usually, an image forming operation of images on side-width sheets is interrupted without being stopped and then a cooling time of the fixing film 51 is set. The temperature of the fixing film 51 in the non-sheet passing region A reaches a higher temperature as the narrow-width sheets are passed through the fixing device 50. That is, a time required for cooling the fixing film 51 is longer with an increasing number of passing sheets.

Incidentally, the image forming apparatus is operated in many instances in some printing modes (image forming modes) different in sheet conveyance speed. A mode in which the sheet conveyance speed of the image forming apparatus is highest is referred to as a full-speed mode, and a mode in which the sheet conveyance speed of the image forming apparatus is half of the highest speed is referred to as a half-speed mode. In the case where temperature control values of the fixing device 50 in operations in the full-speed mode and the half-speed mode are compared with each other, the temperature control value in the operation in the full-speed mode is higher than the temperature control value in the operation in the half-speed mode. This is because in the operation in the full-speed mode, a time in which the sheet stays in the fixing nip is short and thus there is a need to heat the sheet at a high temperature.

Here, the case where immediately after a first printing job in which narrow-width sheets are passed through the fixing device, a second printing job in which wide-width sheets are passed through the fixing device is subsequently performed continuously will be considered. In the case where in the first printing job, the narrow-width sheets are passed through the fixing device in the operation in the full-speed mode, the full-speed mode is a mode in which the sheet conveyance speed is highest, and therefore, a sheet passing time per (one) sheet is short. Therefore, unless a high temperature control value is set, the toner image cannot be stuck on the sheet. The temperature control value is high, so that the non-sheet passing portion is liable to reach a high temperature. In order to suppress an occurrence of the hot offset on a subsequent wide-width sheet, in many cases, there is a need that a time for cooling the non-sheet passing portion is long. In summary, in the operation in the full-speed mode such that the conveyance speed is fast, the sheet passing time necessary for one sheet is short but the time necessary for cooling the fixing film is long. On the other hand, the case where in the first printing job, the narrow-width sheets are passed through the fixing device in the operation in the half-speed mode, the half-speed mode is a mode in which the conveyance speed is slow, and therefore, the sheet passing time per sheet is long. Therefore, even when a high temperature control value is not set, the toner image can be stuck on the sheet. That is, the temperature control value is low, and therefore, the non-sheet passing portion does not reach the high temperature. Further, in many case, a cooling time for suppressing the occurrence of the hot offset of a subsequent wide-width sheet is not needed. In summary, in the operation in the half-speed mode in which the conveyance speed is slow, although the sheet passing time necessary for one sheet becomes long, the cooling time is not needed or is short.

In the case where immediately after the first printing job in which the narrow-width sheets are passed through the fixing device, the second printing job in which the wide-width sheets are passed through the fixing device is subsequently performed continuously, the following problem arises. That is, there is a possibility that whether or not a total time obtained by summing an execution time of the first printing job and the cooling time can be shortened in which one of the operation in the full-speed mode and the operation in the half-speed mode is different depending on the number of passing sheets and the cooling time. For this reason, there is a problem such that a user providing a print (printing) instruction cannot always receive a print, obtained by a preceding first printing job and a subsequent second printing job, in a shortest time.

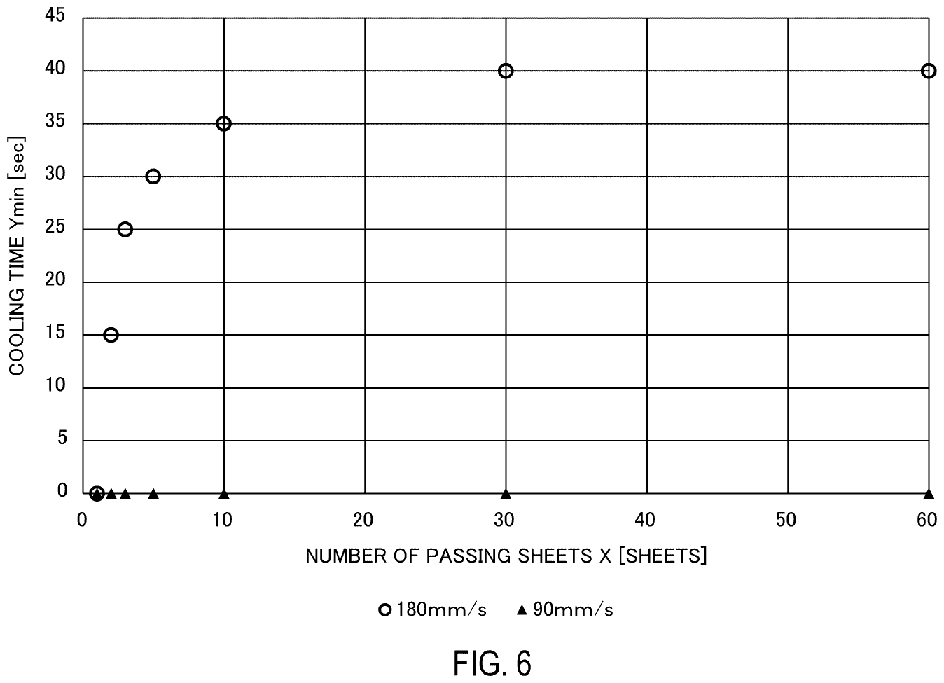

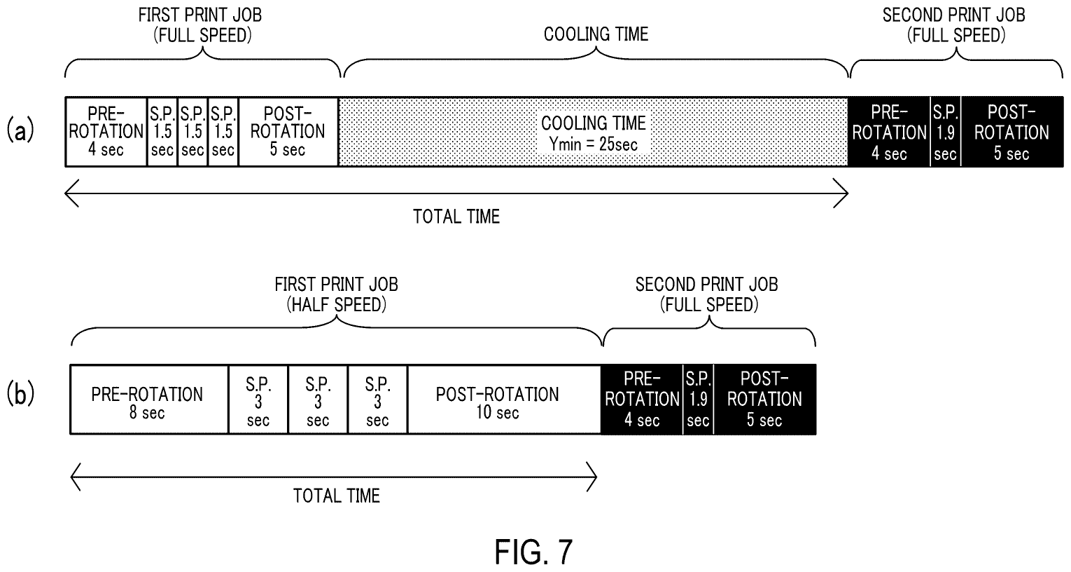

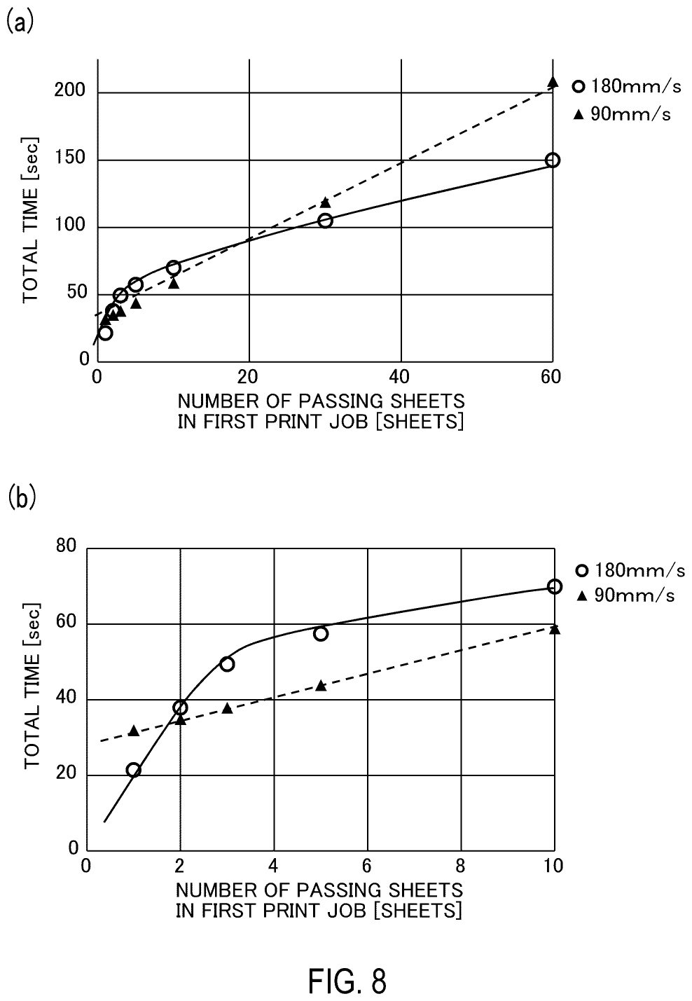

Here, a relationship between the number of passing sheets and the cooling time is checked. A checking condition is shown below. Operations in two kinds of sheet passing modes (printing modes) are checked. A first sheet passing mode is referred to as the full-speed mode as a first printing mode, and the fixing device 50 is 220° C. in control temperature value and is 180 mm/sec in sheet conveyance speed (first conveyance speed). A second sheet passing mode is referred to as the half-speed mode as a second printing mode, and the fixing device 50 is 180° C. in temperature control value and is 90 mm/sec in sheet conveyance speed (second conveyance speed). As a common sheet passing condition, the narrow-width sheet is an A5-size sheet, the wide-width sheet in an A4-size sheet, and a sheet kind is 80 g-paper (basis weight: 80 gsm, “GF-C081”, manufactured by CANON KABUSHIKI KAISHA). A checking procedure is as follows. In a state in which the fixing device 50 is cool, X sheets of A5-size sheets are passed through the fixing device 50. After continuous passing of the X sheets is completed, the fixing device 50 is interrupted for Y seconds. After the interruption for Y seconds, one A4-size sheet is passed through the fixing device 50. Here, the time of the interruption of the fixing device 50 is referred to as an interruption time or the cooling time. Then, occurrence or non-occurrence of the hot offset on the A4-size sheet is checked. In various conditions, the above-described procedure is repeated and a minimum interruption time (cooling time) Ymin in which the hot offset does not occur is acquired, so that the graph of FIG. 6 was prepared.

FIG. 6 shows a check result, in which an abscissa represents the number of process X [sheets] and an ordinate represents the cooling time Ymin [sec]. A plot “◯” shows a result for the full-speed mode, and a plot “▴” shows a result for the half-speed mode. According to the result for the full-speed mode, with an increasing number of printing job, a necessary cooling time Ymin is longer.

Further, it was also confirmed that the cooling time Ymin was saturated at 40 seconds approximately from exceeding 30 sheets in number of passing sheets X. On the other hand, according to the result for the half-speed mode, it was confirmed that irrespective of the number of passing sheets X, the cooling time Ymin is 0 seconds, i.e., is not needed (there is no need to provide the cooling time). This would be considered because the temperature control value is low in the operation in the half-speed mode and a degree of the temperature rise in the non-sheet passing region A when the narrow-width sheet is passed through the fixing device is small.

### [Printing Job]

In the above, the offset phenomenon in the case where immediately after the first printing job (narrow-width sheet), the second printing job (wide-width sheet) is subsequently performed, and the cooling time necessary for suppressing the hot offset phenomenon were described. Details operations and execution times of the first printing job and the second printing job, including the cooling time will be described using an example shown in FIG. 7.

Part (a) of FIG. 7 shows the detailed operations and the execution times of the first printing job (continuous three A5-size sheets) during the operation in the full-speed mode, the cooling time Ymin, and the second printing job (one A4-size sheet).

For each of the detailed operations, the operation is distinctly displayed by a rectangular parallelepiped, and lateral width of the rectangular parallelepiped represents the execution time. Definitions of the detailed operations will be described. “PRE-ROTATION” is a time used for stabilizing a rotation speed of the scanner motor of the exposure device 11 and preliminarily heating the fixing device 50, and for forming the image until the toner image on the photosensitive drum 1 is transferred onto the intermediary transfer belt 13 and then is transferred onto the sheet P by the secondary transfer roller 25, i.e., a time from a start of the printing until the sheet P reaches the fixing device 50. “SHEET PASSING (S.P.)” is a time used for passing one sheet from entrance of a preceding sheet into the fixing nip N of the fixing device 50 to entrance of a subsequent sheet into the fixing nip N. “POST-ROTATION” is a time used for executing a sequence in which the toner and a foreign matter which are deposited on surfaces of the transfer roller, the developing roller, the charging roller, and the like after a final sheet passes through the fixing nip N (after completion of the sheet passing) are removed. “COOLING TIME” is a time used for cooling (lowering the temperature of) the fixing device 50 in which the non-sheet passing region A reached the high temperature after the sheet passing of the narrow-width sheet. The cooling time is different depending on the number of passing sheets and the sheet passing mode.

In part (a) of FIG. 7, in the first printing job, it takes 4 seconds for the pre-rotation, 1.5 seconds for sheet passing of each (one) A5-size sheet, and 5 seconds for the post-rotation, and the execution time of the first printing job is 13.5 seconds. Incidentally, the execution time of the first printing job is also a printing completion time from a start to completion of the printing of the first printing job. Further, the cooling time Ymin is 25 seconds. In the second printing job, it takes the 4 seconds for the pre-rotation, 1.9 seconds for sheet passing of one A4-size sheet, and 5 seconds for the post-rotation, and the execution time of the second printing job is 10.9 seconds. From the above, in part (a) of FIG. 7, it takes 49.9 seconds from a start of the first printing job to an end of the second printing job.

Part (b) of FIG. 7 shows the detailed operations and the execution times of the first printing job (continuous three A5-size sheets) during the operation in the full-speed mode, and the second printing job (one A4-size sheet). In part (b) of FIG. 7, it takes 8 seconds for the pre-rotation, 3 seconds for sheet passing of each (one) A5-size sheet, and 10 seconds for the post-rotation, and the execution time of the first printing job is 27 seconds. Further, there is no cooling time Ymin. In the second printing job, it takes 4 seconds for the pre-rotation, 1.9 seconds for sheet passing of one A4-size sheet, and 5 seconds for the post-rotation, and the execution time of the second printing job is 10.9 seconds. From the above, in part (b) of FIG. 7, it takes 37.9 seconds from a start of the first printing job to an end of the second printing job.

In part (b) of FIG. 7, a difference from part (a) of FIG. 7 is such that the sheet passing mode of the first printing job is different from that in part (a) of FIG. 7. A total time which is a sum of the execution time of the first printing job and the cooling time Ymin is 38.5 seconds (first total time) in the case of part (a) of FIG. 7 and 27 seconds (second total time) in the case of part (b) of FIG. 7. The execution times of the second printing job are the same between the cases of parts (a) and (b) of FIG. 7, and therefore, only the total times are different between the cases of parts (a) and (b) of FIG. 7. In the example of FIG. 7, when the first printing job is executed by the operation in the half-speed mode (part (b) of FIG. 7), the use is capable of obtain a print in a short time. However, the total time cannot always be minimized even under any sheet passing condition when the first printing job is executed by the operation in the half-speed mode, and a check result thereof will be described later.

### [Number of Passing Sheets and Total Time]

Part (a) of FIG. 8 shows a total time which is a sum of the first printing job and the cooling time Ymin when the first printing job is executed by operations in two sheet passing modes. In a graph of FIG. 8, an abscissa represents the number of printing job [sheets], and an ordinate represents the total time [seconds]. In FIG. 8, a plot “◯” shows a result for the full-speed mode, and a plot “▴” shows a result for the half-speed mode.

In the operation in the full-speed mode, the fixing device 50 is 220° C. in temperature control value and 180 mm/sec in sheet conveyance speed. In the operation in the half-speed mode, the fixing device 50 is 180° in temperature control value and 90 mm/sec in sheet conveyance speed. Incidentally, the cooling time Ymin after the first printing job was calculated from the cooling time Ymin shown in FIG. 6. The narrow-width sheet in the first printing job is an A5-size sheet, and the wide-width sheet is an A4-size sheet. A sheet kind of both the narrow-width sheet and the wide-width sheet is 80 g/paper (“CF-C081”, manufactured by CANON KABUSHIKI KAISHA). Further, the first printing job is executed from a state in which the fixing device 50 is cool.

Part (b) of FIG. 8 is a graph in which a part range of 0 to 10 sheets in number of passing sheets of part (a) of FIG. 8 is enlarged. Part (b) of FIG. 8 shows the total time until the number of passing sheets reaches 10 sheets. According to this, in the case where the number of passing sheets in the first printing job is one (sheet), the total time is short in the case where the first printing job is executed by the operation in the full-speed mode. In the case where the number of passing sheets in the first printing job is from 2 sheets to 10 sheets, the total time is short in the case where the first printing job is executed by the operation in the half-speed mode. Next, according to part (a) of FIG. 8, it is understood that from when the number of passing sheets in the first printing job exceeds 20 sheets, the total time is short in the case where the first printing job is executed by the operation in the full-speed mode. Thus, it was confirmed that depending on the number of passing sheets of the narrow-width sheets in the first printing job, the sheet passing mode in which the total time is minimized is different.

That is, when the sheet passing mode of the first printing job is selected depending on information (number of passing sheets) of the first printing job, the total time can be minimized. This has the same meaning as that an execution time from a start of the first printing job to completion of the second printing job is minimized. By this, the user is capable of obtaining a print in a short time.

### [Flowchart for Determining Printing Mode]

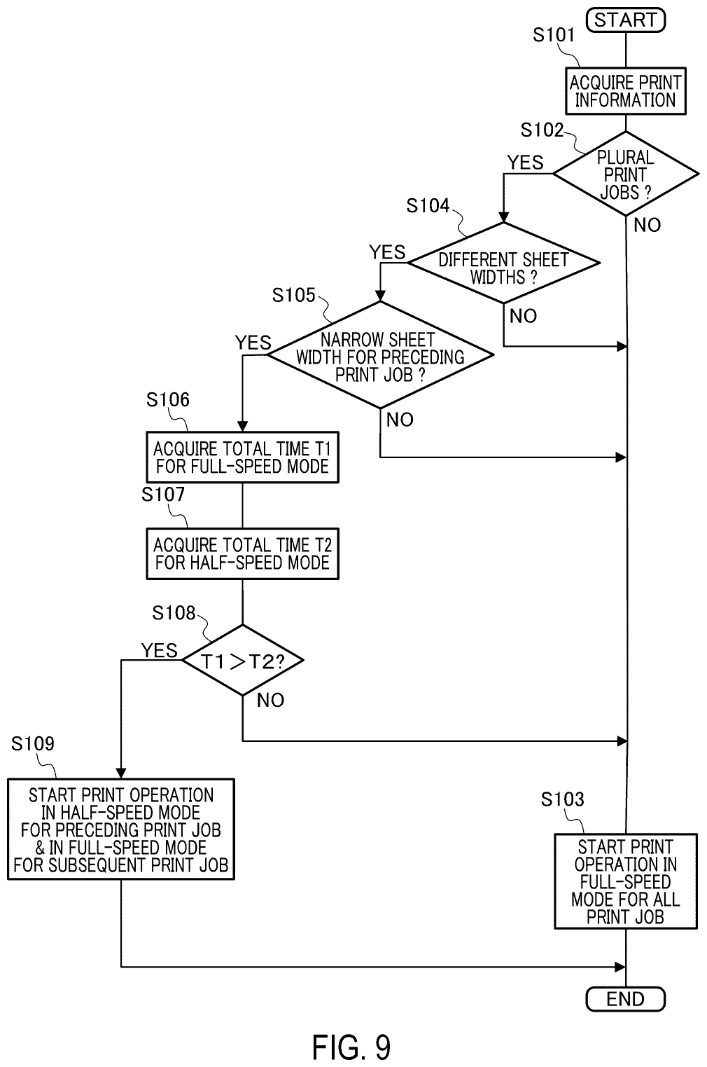

In FIG. 9, processing for selecting the sheet passing mode in the embodiment 1 is shown, and the contacts of the processing will be described. When the user executes print (printing) instruction with use of the PC 110, processing of a step (hereinafter, abbreviated as “S”) 101 and later is started. In S101, the video controller 91 acquires print information. The print information includes the number of passing sheets, image information, and the like. In S102, the CPU 94 acquires the print information from the video controller 91 and discriminates whether or not the printing job (print job) is a plurality of printing jobs. In the case where the CPU 94 discriminated in S102 that the printing job is a single printing job, the CPU 94 causes the processing to go to S103. In the case where the CPU 94 discriminated in S102 that the printing job is the plurality of printing jobs, the CPU 94 causes the processing to go to S104. Incidentally, the plurality of printing jobs refers to a printing job including the first printing job which is the printing job for the narrow-width sheet and the second printing job which is the printing job for the wide-width sheet, as described above. In the case of the single printing job, in S103, the CPU 94 selects the full-speed mode and starts a printing operation in which the single printing job is executed by the operation in the full-speed mode, and then ends the processing.

In S104, the CPU 94 discriminates whether or not sheet widths for the plurality of printing jobs are different from each other. In the case where the CPU 94 discriminated in S104 that the sheet widths for the plurality of printing jobs are different from each other, the CPU 94 causes the processing to go to S105. In the case where the CPU 94 discriminated in S104 that the sheet widths for the plurality of printing jobs are the same, the CPU 94 causes the processing to go to S103. That is, in the case where the CPU 94 discriminated that the sheet widths are the same even in the plurality of printing jobs, the CPU 94 selects the full-speed mode.

In S105, the CPU 94 discriminates whether or not of the plurality of printing jobs, a sheet width for a preceding printing job is narrow. In the case where the CPU 94 discriminated in S105 that the sheet width for the preceding printing job is narrow, the CPU 94 causes the processing to go to S106. In the case where the CPU 94 discriminated is S105 that the sheet width for the preceding printing job is wide, the CPU 94 causes the processing to go to S103. That is, the CPU 94 selects the full-speed mode in the case where the sheet width for the preceding printing job is wider than the sheet width for a subsequent printing job.

In S106, the CPU 94 acquires a total time T1 when the printing operation is started in a state in which the plurality of printing jobs are executed by the operation in the full-speed mode. The total time T1 includes operation times of the pre-rotation, the sheet passing, and the post-rotation of the preceding printing job, and includes the cooling time Ymin (see FIG. 7). In S107, the CPU 94 acquires a total time T2 when the printing operation is started in a state in which the plurality of printing jobs are executed by the operation in the half-speed mode. Here, the CPU 94 calculates the total time T1 and the total time T2 on the basis of the print information acquired in S101. The total time T2 includes operation times of the pre-rotation, the sheet passing, and the post-rotation of the preceding printing job, and includes the cooling time Ymin (see FIG. 7).

In S108, the CPU 94 discriminates whether or not the total time T1 acquired in S106 is longer than the total time T2 acquired in S107. In the case where the CPU 94 discriminated in S108 that the total time T1 is longer than the total time T2 (T1>T2), the CPU 94 causes the processing to go to S109. In the case where the CPU 94 discriminated in S108 that the total time T1 is equal to or shorter than the total time T2 (T1≤T2), the CPU 94 causes the processing to go to S103. In S108, the CPU 94 starts the printing operation in a state in which the preceding printing job is executed by the operation in the full-speed mode and in which the subsequent printing job is executed by the operation in the half-speed mode, and then ends the processing. Thus, the CPU 94 starts the printing operation in the preceding printing job executed by the operation in the sheet passing mode having the shorter total time, depending on a discrimination result of S108.

### [Warming-Up State of Fixing Device]

In the above, the printing operation from the state in which the fixing device 50 is cool was described, and in the following, a printing operation from a state in which the fixing device 50 is not cool will be described. Correspondingly to the state in which the fixing device 50 is not cool, the non-sheet passing region A reaches a high temperature earlier, so that even when the number of passing sheets is the same, a heat accumulation amount of the fixing film 51 and the pressing roller 53 is large. That is, in the case where the fixing device 50 is not cool, compared with the case where the fixing device 50 is cool, the cooling time Ymin for the number of passing sheets is required to be set longer.

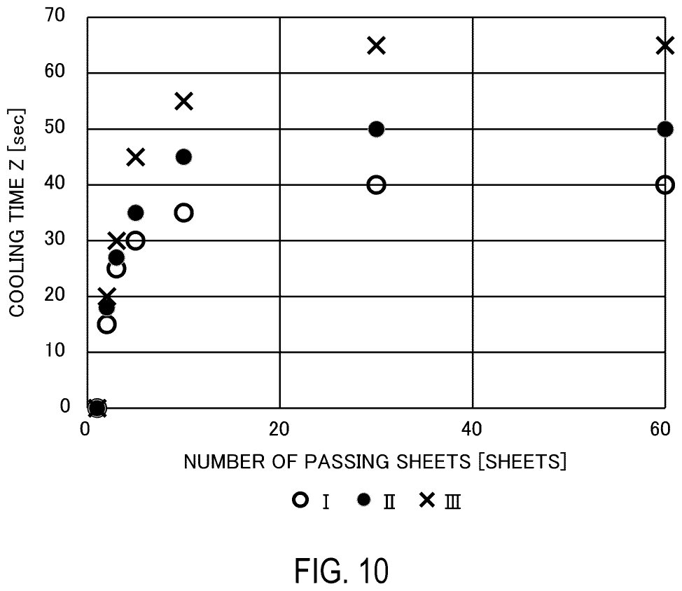

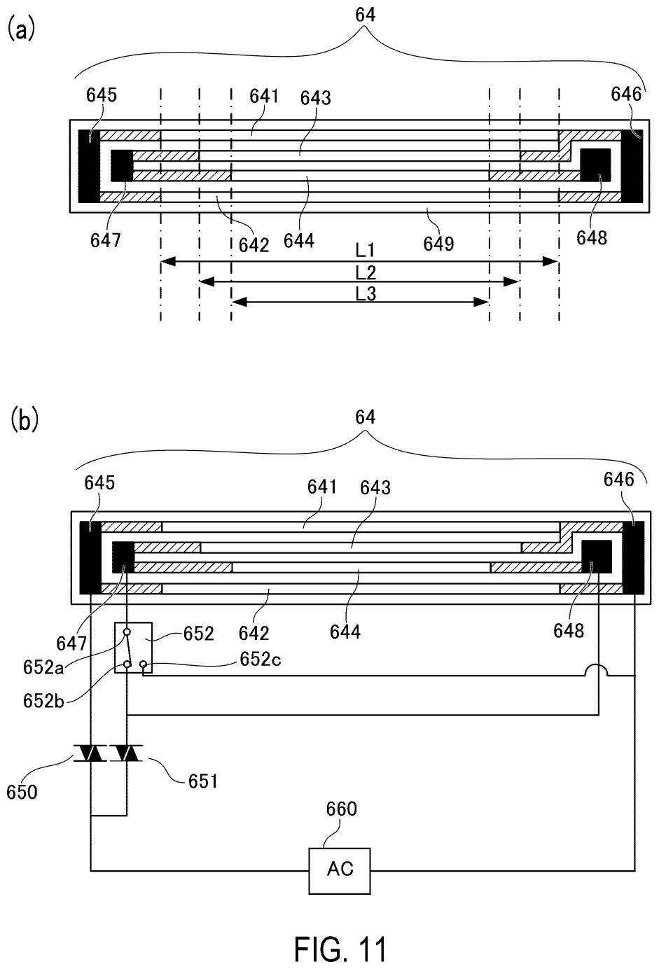

FIG. 10 shows a relationship of the cooling time with respect to the heat accumulation state of the fixing device 50. In FIG. 10, an abscissa represents the number of passing sheets [sheets] for the printing job, and an ordinate represents a cooling time Z [sec] after the printing job. In FIG. 10, the cooling times Z for three states consisting of a state I (“◯”) in which the fixing device 50 is cool, a state II (“x”) in which the fixing device 50 is moderately warm, and a state III (“x”) in which the fixing device 50 is at a high temperature. Incidentally, in the embodiment 1, a detection result of the fixing temperature sensor is less than 30° C. in the state I, 30° C. or more and less than 100° C. in the state II, and 100° C. or more in the state III.

In either one of the states I, II, and III, until the number of passing sheets in the printing job reaches 10 sheets, with an increasing number of passing sheets in the printing job, the cooling time Z becomes longer. In addition, in either one of the states I, II, and III, when the number of passing sheets in the printing job is 30 sheets or more, the cooling time Z becomes a certain time irrespective of the number of passing sheets in the printing job. When the respective states are compared with each other at a fixed number of passing sheets, even in the same number of passing sheets, the cooling time Z is short in the state I and a long in the state III. That is, when the cooling times Z in the states I, II, and III are Z1, Z2, and Z3, respectively, Z1<Z2<Z3 holds. Thus, even in the same number of passing sheets, the cooling time Z is different depending on a state of the printing from what state. For this reason, when the total times T1 and T2 are acquired in the processing of S106 and the printing of S107, respectively, shown in FIG. 9, there is a need to consider a different cooling time Z depending on the warming-up state of the fixing device 50. On the basis of FIG. 10, when the CPU 94 acquires the total time T1 in the operation in the full-speed mode of S106 and the total time T2 in the operation in the half-speed mode of S107, the CPU 94 may only be required to execute the following operation. That is, the CPU 94 may only be required to execute an operation so that the cooling time Z in the case where the fixing device 50 is warm is longer than the cooling time Z in the case where the fixing device 50 is cool.

As described above, in the embodiment 1, an optimum sheet passing mode in which the first printing job for printing the image on the narrow-width sheet by utilizing information such as the number of passing sheets and the cooling time, so that the total time of the first printing job, the cooling time, and the second printing job can be minimized.

Incidentally, in the embodiment 1, the first printing job and the second printing job were described as an example, but even when three or more different printing jobs are continued, by a similar method, an effect can be achieved similarly.

Further, in the embodiment 1, a method for calculating the execution times of the first printing job and the second printing job was proposed, but the execution time calculating method is not limited thereto. For example, the relationship between the number of passing sheets in the first printing job and the total time is changed to an arithmetic expression or is tabulated every sheet size and then may be held (stored) in the memory 95 of the engine controller 92. The CPU 94 may only be required to select the sheet passing mode capable of minimizing the total time by inquiring the number of passing sheets in the first printing job, and the arithmetic expression or the table stored in the memory 95. By this, calculation processing of the execution time by the CPU 94 can be omitted.

In the embodiment 1, the case where the printing information of the first printing job and the second printing job exists in the engine controller 92 before the start of the printing operation was described, but is not limited thereto. Depending on a size of the printing job, there is an undermined case such that the printing information does not each the engine controller before the start of the image forming operation. Thus, in the case where the information of the first printing job and the information of the second printing job are undermined, in the first printing job, the printing operation may be started in the full-speed mode.

In the above, a method in which the user provides the print (printing) instruction from the PC 110 to the engine controller 92 and printing information thereof is processed by the engine controller 92 was described, but is not limited thereto. For example, there is a case where the engine controller 92 has a “regular print (printing mode” in which printing information on a print order, the number of printed sheets, or the like is determined in advance. Also, in such a case, it is possible to obtain an effect of the present disclosure. In this case, the printing information is determined before the printing operation, so that the print can always be supplied in a shortest time.

As an example of the regular print mode, an example of a regular print mode in Japan will be described. For example, in medical institutions, a regular print mode such that a one A5-size medical free statement is printed in the first printing job and a one A4-size medicine information sheet is printed in the second printing job is used. In the case where a person concerned of the medical institution provides a print instruction in a printer in which the regular print mode is enabled, the medical fee statement (A5) and the medicine information sheet (A5) are collectively printed. The person concerned of the medical institution provides the two printed sheets to a patient.

Thus, even in the case where the regular print mode is selected, on the basis of printing information of a preceding printing job and a subsequent printing job, in accordance with the processing described in the embodiment 1, the total time is calculated, whereby it is possible to provide the user with the print in a shortest time.

As described above, according to the embodiment 1, in the case where the images re printed on the wide-width sheet subsequently to the narrow-width sheet, a time until the printing of the images on the narrow-width sheet and the wide-width sheet is completed can be shortened.

### Embodiment 2

As an embodiment 2, the case where a fixing device 50 in which a heater 54 includes a plurality of heat generating elements different in length in a longitudinal direction is utilized will be described. An image forming apparatus 200 has the same specifications as those of the image forming apparatus 200 in the embodiment 1, and therefore, similar constituent elements are represented by similar reference numerals or symbols and will be omitted from description.

### [Heater]

Main component parts of the fixing device 50 have the same specifications as those in the embodiment 1 and will be omitted from description. A heater 64 different the heater 54 in the embodiment 1 and electric power control of the heater 64 will be described. In part (a) of FIG. 11, the heater 64 in the embodiment 2 is shown. The length of the heat generating element 54a of the heater 54 in the longitudinal direction in the embodiment 1 was the single length (length H1) (see FIG. 4). On the other hand, the heater 64 in the embodiment 2 includes a plurality of heat generating elements different in length in the longitudinal direction. Specifically, the heater 64 includes heat generating elements 641 and 642 (first heat generating element) each having a length L1 which is a first length, a heat generating element 643 (third heat generating element) having a length L2 which is a third length, and a heat generating element 644 (second heat generating element) having a length L3 which is a second length. Here, the length L2 of the heat generating element 643 is shorter than the length L1 of the heat generating elements 641 and 642, and a length L3 of the heat generating element 644 is shorter than the length L2 of the heat generating element 643 (L1>L2>L3). For example, the length L1 is 222 mm, the length L2 is 188 mm, and the length L3 is 154 mm.

Further, these heat generating elements are arranged on a substrate 649 in an order of the heat generating element 641 (fourth heat generating element disposed in one end portion), the heat generating element 643, the heat generating element 644, and the heat generating element 642 (fifth heat generating element disposed in the other end portion) with respect to a widthwise direction (also, a conveyance direction). That is, with respect to the widthwise direction, between the two heat generating elements 641 and 642, the heat generating element 643 and the heat generating element 644 are disposed symmetrically with each other.

Further, each of the heat generating elements is connected by a contact. The heat generating element 641 and the heat generating element 642 are connected by a first contact 645 in one end portion with respect to the longitudinal direction and are connected by a second contact 646 in the other end portion with respect to the longitudinal direction. Further, the heat generating element 643 and the heat generating element 644 are connected by a third contact 647 in the one end portion with respect to the longitudinal direction. The heat generating element 643 is connected to the contact 646 in the other end portion, and the heat generating element 643 is connected to a fourth contact 648 in the other end portion.

In part (b) of FIG. 11, an electric circuit diagram of the heater 64 in the embodiment 2. An AC power source 660 is connected between the first contact 645 and the second contact 646, so that a current is passed toner the heat generating element 641 and the heat generating element 642 and thus heat is generated. Incidentally, between the first contact 645 and the second contact 646, a bidirectional thyristor (hereinafter, referred to as a triac) 650 as a first connecting means is connected. The CPU 94 turns on the triac 650 to supply the current to the heat generating elements 641 and 642 (connection state), and turns off the triac 650 to interrupt (cut off) the supply of the current to the heat generating elements 641 and 642 (non-connection state).

Between the second contact 646 and the third contact 647, the AC power source 660 is connected, so that the current is passed through the heat generating element 643 and thus heat is generated. Here, a C relay 652 shown in part (b) of FIG. 11 is capable of changing a path by a DC voltage. In other words, the CPU 94 controls the C relay 652, so that the CPU 94 is capable of switching the connection state of the C relay 652. The C relay 652 has contacts 652a, 652b, and 652c, and is switched between a first connection state (solid line) in which the contact 652a and the contact 652b are connected to each other and a second connection state in which the contact 652a and the contact 652c are connected to each other. A path through which the current flows when the C relay 652 is switched to the first connection state is referred to as a first (electro) conduction path, and a path through which the current flows when the C relay 652 is switched to the second connection state is referred to as a second conduction path.

As shown in part (b) of FIG. 11, when the C relay 652 is in the first connection state, the current can be passed through the heat generating element 643 in the first electroconductive path. Further, when the C relay 652 is in the second connection state, the current can be passed through the heat generating element 644 in the second conduction path. Incidentally, to a portion common to the first and second conduction paths, a triac 651 as a second connecting means is connected on a way of the path. The CPU 94 turns on the triac 651 to supply the current to the heat generating element 643 or the heat generating element 644, and turns off the triac 651 to interrupt the supply of the current to the heat generating element 643 or the heat generating element 644.

A voltage is applied to the C relay 652, and the electroconductive path is switched from the first electroconductive path to the second (the other) conduction path shown in part (b) of FIG. 11. Then, an AC voltage is applied to between the third contact 647 and the fourth contact 648, so that the current is passed through the heat generating element 644 and thus heat is generated. The CPU 94 changes the heat generating element used in conformity to the sheet size. Three kinds of sheet sizes in a using method of the heater 64 will be described.

### (Case of Passing of A4-Size Sheet)

In the case of passing of the A4-size sheet, the CPU 94 controls the circuit of part (b) of FIG. 11 so as to use only the heat generating elements 641 and 642. The CPU 94 calculates a difference A between an output value and a target control temperature of the fixing temperature sensor 59. The CPU 94 performs control so that input wave number of the AC voltage is increased with an increasing difference A and is decreased with a decreasing difference A. Here, in the embodiment 2, wave number control in which electric power control is performed in a cyclic period including a plurality of half-waves of the AC voltage. By this control, the output value of the fixing temperature sensor 59 can be conveyed to the target control temperature. The control of the input wave number of the AC voltage can be executed by controlling a gate voltage of the triac 650. Incidentally, the electric power control may also be phase control or hybrid control of the wave number control and the phase control.

### (Case of Passing of B5-Size Sheet)

In the case of a B5-size sheet, the CPU 94 controls the circuit of part (b) of FIG. 11 so as to use the heat generating elements 641 and 642 and the heat generating element 643. Similarly as in the case of the passing of the A4-size sheet, the CPU 94 controls the AC voltage input wave number, so that the output value of the fixing temperature sensor 59 is converted to the target control temperature. However, the CPU 94 switches the heat generating element, to which the AC voltage is applied, at a timing determined in advance, so that the heat generating elements 641 and 642, and the heat generating element 643 are used alternately or, in other words, exclusively.

A heat generating element switching timing by the CPU 94 will be described. The memory 95 includes a use time ratio table of heat generating elements in which 80 msec is a minimum unit, and the CPU 94 controls the circuit so that the heat generating element to which the AC voltage is applied is switched on the basis of the use time ratio table in the memory 95. For example, in the case where an AC voltage frequency is 50 Hz, there are 50 waves per second, in other words 100 half waves per second, and under this condition, application of 8 half wave of the AC voltage means that the AC voltage is applied for 80 msec.

For example, in the case where the use time ratio between the heat generating elements 641 and 642, and the heat generating element 643 is 1:5, the CPU 94 performs the following control. The CPU 94 performs control so that the heat generating elements 641 and 642 are used for 80 msec and then the heat generating element used is switched to the heat generating element 643, which is used for 5×80 msec=400 msec, and then the heat generating element used is switched to the heat generating element, 641 and 642. The CPU 94 repeats this control. Incidentally, the control of the AC voltage input wave number of the heat generating element 643 can be executed by controlling a gate voltage of the triac 651.

### (Case of Passing of A5-Size Sheet)

In the case of passing of the A5-size sheet, the CPU 94 controls the circuit of part (b) of FIG. 11 so as to use the heat generating elements 641 and 642, and the heat generating element 644. A DC voltage is applied to the C relay 652, so that the conduction path is switched from the first conduction path to the second conduction path and thus a current path of the heat generating element 644 is formed. Similarly as the heat generating element 643, the AC voltage input wave number control of the heat generating element 644 can be executed by controlling the gate voltage of the triac 651. The target control temperature of the heater 64 and the use time ratio of the heat generating elements are the same as those in the case of passing of the B5-size sheet, and therefore, will be omitted from description.

In the embodiment 2, the control by the use time ratio of the heat generating elements was described, but the CPU 94 may also perform the switching control based on an input wave number ratio of the AC voltage or an electric power ratio.

### [Use Time Ratio]

The use time ratio will be described using, as an example, the case of passing of the A5-size sheet, i.e., the case where the heat generating elements 641 and 642, and the heat generating element 644 are used. Use restriction when the heat generating element 644 short in length in the longitudinal direction is used will be described. In a state in which the fixing device 50 is cool, when only the heat generating element short in length in the longitudinal direction is used, the fixing film 51 having a thin layer is twisted off in some cases. With respect to the longitudinal direction, in a region of the heat generating element 644 (length L3), the pressing roller 53 is heated and therefore expanded, so that an external diameter thereof becomes large. On the other hand, outside the region of the heat generating element 644, the pressing roller 53 is not heated, so that the outer diameter thereof is unchanged. That is, with respect to the longitudinal direction, a state in which the outer diameter of the pressing roller 53 is larger in a central portion than in opposite end portions is formed. The pressing roller 53 causes the fixing film 51 to be rotation-operated, so that a rotational speed of the fixing film 51 is influenced by the outer diameter of the pressing roller 53. Therefore, the rotational speed of the fixing film 51 in the opposite end portions with respect to the longitudinal direction becomes slower than the rotational speed of the fixing film 51 in the central portion with respect to the longitudinal direction. In such a state, the fixing film 51 receives a force by which the fixing film 51 is shifted toward the central portion with respect to the longitudinal direction, so that there is a liability that the fixing film 51 is buckled in the central portion with respect to the longitudinal direction and then leads to breakage such that the fixing film 51 is twisted off.

Therefore, depending on a degree of warming of the fixing device 50 before the start of the printing operation, there is a need to provide restriction on a use frequency of the heat generating element 644. The use frequency of the heat generating element 644 is set lower as the fixing device 50 is cooler, and is set higher as the fixing device 50 is warmer. When the fixing device 50 is warmed, a breakage risk of twisted-off of the fixing film 51 is small, so that in order to suppress the non-sheet passing temperature rise during the passing of the narrow-width sheet, the use frequency of the heat generating element short in length in the longitudinal direction is made high. Incidentally, when the heat generating elements 641 and 642 are used, the heat generating element 644 is not used, and when the heat generating element 644 is used, the heat generating elements 641 and 642 are not used. That is, the CPU 94 exclusively uses the heat generating elements 641 and 642, and the heat generating element 644.

In a table 1 below, a relationship between a warming-up zone, an output value T of the fixing temperature sensor 59, and a use time ratio of the heat generating elements is shown. In the table 1, a first column shows the warming-up zone, a second column shows the output value T before the start of the printing operation, and a third column shows the use time ratio of the heat generating elements. Incidentally, in the table 1, the use time ratio between the heat generating elements 641 and 642, and the heat generating element 644.

TABLE 1

| WUZ*¹ | OUTPUT VALUE T*² | USE TIME RATIO*³ |
|---|---|---|
| 1 | T ≤ 30 | 10:0 |
| 2 | 30 < T ≤ 60 | 8:2 |
| 3 | 60 < T ≤ 100 | 6:4 |
| 4 | 100 < T ≤ 150 | 3:7 |
| 5 | T > 150 | 1:9 |

*¹“WUZ” is the warming-up zone.
*²“OUTPUT VALUE T” is the output value T of the fixing temperature sensor 59 before the start of the printing operation.
*³“USE TIME RATIO” is the use time ratio of (heat generating elements 641 and 642):(heat generating element 644).

A degree of warming before the start of the printing operation is distinguished into 5 stages, which are defined as warming-up zones 1 to 5, respectively. The warming-up zone is determined from the output value T of the fixing temperature sensor 59. As a numerical value of the warming-up zone becomes larger, the output value T of the fixing temperature sensor 59 becomes higher before the printing operation is started. The warming-up zone is determined as the warming-up zone 1 when T≤30° C. holds, the warming-up zone 2 when 30° C.<T≤60° C. holds, the warming-up zone 3 when 60° C.<T≤100° C. holds, the warming-up zone 4 when 100° C.<T≤150° C. holds, and the warming-up zone 5 when T>150° C. holds.

In the warming-up zone 1, the heat generating element 644 is not used, and the use time ratio between the heat generating elements 641 and 642, and the heat generating element 644 is 10:0. Depending on an increase in warming-up zone value, setting is made so that the use time ratio (use ratio of the heat generating element 644 to the heat generating elements 641 and 642) becomes high. Incidentally, the heat generating elements 641 and 642 are set so as to become relatively smaller in use ratio with and increasing value of the warming-up zone.

The warming-up zone before the start of the printing operation and the use time ratios of the heat generating elements are as described above. The fixing device 50 is also heated during the sheet passing, so that there is a need to increase the warming-up zone depending on a degree of heating. The increase in warming-up zone means that the warming-up zone is transferred (shifted) from 1 to 2, 2 to 3, . . . , and the like. In the embodiment 2, the number of passing sheets is counted, and when the counted number of passing sheets exceeds a threshold, the warming-up zone is increased by 1.

In a table 2 below, a relationship between the warming-up zone and the threshold of the number of passing sheets is shown, and a specific example in which the warming-up zone is transferred will be described later. In the table 2, a first column shows the warming-up zone, a second column shows the threshold depending on the number of passing sheets, and a third column shows the use time ratio of the heat generating elements. Incidentally, the use time ratio is the same as the use time ratio in the table 1.

TABLE 2

| WUZ*¹ | THRESHOLD*² | USE TIME RATIO*³ |
|---|---|---|
| 1 | 5 SHEETS | 10:0 |
| 2 | 10 SHEETS | 8:2 |
| 3 | 15 SHEETS | 6:4 |
| 4 | 20 SHEETS | 3:7 |
| 5 | NONE | 1:9 |

*¹“WUZ” is the warming-up zone.
*²“THRESHOLD” is the threshold of the number of passing sheets.
*³“USE TIME RATIO” is the use time ratio of (heat generating elements 641 and 642):(heat generating element 644).

In the case where the printing operation is started in a state in which the fixing device 50 is cool, for the warming-up zone 1, the use time ratio is started at 10:0. Under this condition when a counted number of passing sheets reaches 5 sheets, the warming-up zone is increased by 1 and is transferred to the warming-up zone 2, and the use time ratio is changed to 8:2. Further, when the number of passing sheets is continued by 5 sheets and reaches 10 sheets, in other words, when a total number of passing sheets exceeds the threshold (10 sheets) of the warming-up zone 2, the warming-up zone is further increased by 1 and is transferred to the warming-up zone 3 and the use time ratio is changed to 6:4.

The threshold of the number of passing sheets is set to a larger value with an increasing value of the warming-up zone, and in other words in accordance with the table 1, with an increasing output value T of the fixing device 50 before the printing operation is started.

Incidentally, after the warming-up zone is transferred to the warming-up zone 5, the CPU 94 stops the counting of the number of passing sheets and makes the use time ratio constant (fixes the use time ratio at 1:9). For this reason, the threshold in the warming-up zone 4 in the table 2 is “NONE”.

### [Cooling Time]

Here, the cooling time after the narrow-width sheets are passed through the fixing device 50 will be described. In the embodiment 1, the method in which the cooling time is increased depending on the number of passing sheets was described. In the embodiment 2, the use time ratio of the heat generating elements is different depending on the warming-up zone and the number of passing sheets. In the case where the value of the warming-up zone is large and in the case where the number of passing sheets is large, the use time ratio of the heat generating element 644 is high. That is, when the narrow-width sheets are passed through the fixing device 50, a use frequency of the heat generating elements short in length in the longitudinal direction is high, so that the non-sheet passing region temperature rise does not readily occur or the temperature of the non-sheet passing region does not reach a high temperature. The use time ratio correlates with the temperature of the non-sheet passing region, and therefore, in the embodiment 2, the cooling time is determined by making reference to the use time ratio. Here, as regards the use time ratio of the heat generating elements, the cooling time is made shorter with an increasing use frequency of the heat generating element short in length in the longitudinal direction, in other words, with an increasing value of the warming-up zone (see the table 2). It is desirable that a reference timing of the use time ratio of the heat generating elements is a timing when the preceding printing job is ended.

In Table 3, a relationship between the warming-up zone, the use time ratio, and the cooling time is shown. In the table 3, a first column shows the warming-up zone, a second column shows the use time ratio of the heat generating elements, and a third column shows the cooling time. The use time ratio is the same as the use time ratio in the table 1. The use time ratio is increased depending on the value of the warming-up zone. Correspondingly thereto, the cooling time is decreased.

TABLE 3

| WUZ*¹ | USE TIME RATIO*² | COOLING TIME (sec) |
|---|---|---|
| 1 | 10:0 | 30 |
| 2 | 8:2 | 25 |
| 3 | 6:4 | 10 |
| 4 | 3:7 | 5 |
| 5 | 1:9 | 0 |

*¹“WUZ” is the warming-up zone.
*²“USE TIME RATIO” is the use time ratio of (heat generating elements 641 and 642):(heat generating element 644).

In the above, a cooling time calculating method different from that in the embodiment 1 was described. Execution contents other than the cooling time calculation are similar to those in the embodiment 1, and therefore will be omitted from detailed description.

Also, in the embodiment 2, the flowchart of FIG. 9 described in the embodiment 1 is executed and the optimum sheet passing mode of the first printing mode for the narrow-width sheet is selected, so that the total time of the execution time of the first printing job, the cooling time, and the execution time of the second print can be minimized. That is, also in the embodiment 2, the CPU 94 calculates the total times T1 and T2 in S106 and S107 of FIG. 9. At this time, the CPU 94 makes reference to the table 3 and acquires the cooling time depending on the output value T detected by the fixing temperature sensor 59 before the printing operation, and then, the CPU 94 calculates the total times T1 and T2 by using the acquired cooling time.

### Modified Embodiments

In the following, a method of further shortening the cooling time will be decreased. In the embodiments 1 and 2, the methods in which the relationship between the number of passing sheets and the cooling time or between the use time ratio of the heat generating elements and the cooling time was prepared in advance, and then the cooling time was calculated by making reference to the number of passing sheets in the printing job and the use time ratio of the heat generating elements were described. In these methods, the temperature of the non-sheet passing region of the fixing device 50 is not measured directly. That is, the fixing temperature sensor 59 is disposed in the central portion with respect to the longitudinal direction, and the output value T of the fixing temperature sensor 59 is a detection result in the central portion with respect to the longitudinal direction. Thus, the cooling time is just for a predicted value of the temperature of the non-sheet passing region, and therefore, a fluctuation in prediction is taken into account, and some margin is added to the cooling time.

For example, when a plurality of fixing temperature sensors are disposed with respect to the longitudinal direction of the fixing device 50, specifically, when these fixing temperature sensors are disposed in the non-sheet passing region, the temperature of the non-sheet passing region of the fixing device 50 can be directly measured. Further, a temperature from a completion of the printing operation until cooling in the non-sheet passing region is ended (i.e., a cooling completion time) is set in advance. When the detection result of the fixing temperature sensors disposed in the non-sheet passing region becomes below the temperature set in advance, the CPU 94 may only be required to perform control so that the cooling is completed and then a subsequent printing job is started. When this method is used, there is no need to add the margin to the cooling time, so that the cooling time can be shortened correspondingly.

Further, in the above-described embodiments, the first printing job and the second printing job were described as an example, but even when three or more printing jobs are continued, by a similar method, an effect can be achieved similarly.

Further, a method for calculating the execution times of the first printing job and the second printing job was proposed, but the execution time calculating method is not limited thereto, and there is a method other than the method. For example, the relationship between the number of passing sheets in the first printing job and the total time is changed to an arithmetic expression or is tabulated every sheet size and then is held (stored) in the memory 95. The CPU 94 may only be required to select the printing mode for a minimum total time by inquiring the number of passing sheets in the first printing job, and the arithmetic expression or the table stored in the memory 95. By this, calculation processing of the execution time by the CPU 94 can be omitted.

As described above, according to the embodiment 2, in the case where the images re printed on the wide-width sheet subsequently to the narrow-width sheet, a time until the printing of the images on the narrow-width sheet and the wide-width sheet is completed can be shortened.

### OTHER EMBODIMENTS

The above-described embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Features of the present disclosure will become apparent from the following description of embodiments with reference to the attached drawings. The following description of embodiments are described by way of example.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-092489, filed on Jun. 6, 2024, which is hereby incorporated by reference herein in its entirety.

What is claimed is:

1. An image forming apparatus comprising:
a fixing device including a heater and for heating a toner image, carried on a recording material, by the heater; and
a controller configured to perform control in which an image is printed on the recording material by an operation in a first printing mode for performing image formation while conveying the recording material at a first conveying speed or in which the image is printed on the recording material by an operation in a second printing mode for performing the image formation while conveying the recording material at a second conveying speed slower than the first conveying speed,
wherein when a length of the recording material in a direction perpendicular to a conveying direction of the recording material is a width, a job in which the image is printed on a first sheet having a first width as the width is a first printing job, a job which the image is printed on a second sheet having a second width wider than the first width and conveyed subsequently to the first sheet is a second printing job, a time in which cooling of the heater is executed after the first printing job is ended is a cooling time, and a time obtained by summing the cooling time and a print completion time from a start of printing of the first printing job to completion thereof is a total time,
the controller executes the first printing job by an operation in a printing mode in which the total time becomes shorter between a total time when the controller executes the first printing job by the operation in the first printing mode and a total time when the controller executes the first printing job by the operation in the second printing mode.

2. An image forming apparatus according to claim 1, wherein in a case where the first width is narrower than the second width, the controller calculates a first total time when the controller executes the first printing job by the operation in the first printing mode and a second total time when the controller executes the first printing job by the operation in the second printing mode, and executes the first printing job by an operation in a printing mode in which the total time becomes shorter between the first total time and the second total time.

3. An image forming apparatus according to claim 2, wherein the controller discriminates whether or not the first width is narrower than the second width, on the basis of acquired printing information.

4. An image forming apparatus according to claim 1, wherein the cooling time becomes longer with an increasing number of printed sheets in the first printing job.

5. An image forming apparatus according to claim 4, wherein the cooling time becomes longer at a higher temperature of the heater when the first printing job is started even in the same number of printed sheets.

6. An image forming apparatus according to claim 3, wherein the printing information includes information of the width of the recording material and information of a number of printed sheets in a printing job.

7. An image forming apparatus according to claim 1, wherein the heater includes a heat generating element having a width wider than the first width.

8. An image forming apparatus according to claim 1, wherein the heater is provided so that a longitudinal direction thereof is the direction perpendicular to the conveying direction,
wherein the heater includes a first heat generating element of which length in the longitudinal direction is a first length and a second heat generating element of which length in the longitudinal direction is a second length shorter than the first length, and
wherein in a case where the first width is narrower than the second width, the controller executes the first printing job while switching the first heat generating element and the second heat generating element.

9. An image forming apparatus according to claim 8, wherein the controller increases a use ratio of the second heat generating element to the first heat generating element with an increasing temperature of the heater when the first printing job is started.

10. An image forming apparatus according to claim 9, wherein the cooling time becomes shorter as the use ratio of the second heat generating element is higher.

11. An image forming apparatus according to claim 8, further comprising a detecting unit provided in a center of the heater with respect to the longitudinal direction and configured to detect a temperature of the heater.

12. An image forming apparatus according to claim 8, further comprising a plurality of detecting units which are provided in a center of the heater with respect to the longitudinal direction and in a position different from the center, and which are configured to detect a temperature of the heater.

13. An image forming apparatus according to claim 8, wherein the heater includes a third heat generating element shorter than the first heat generating element and longer than the second heat generating element in the longitudinal direction,
wherein the first heat generating element includes a fourth heat generating element provided in one end portion of the heater with respect to a widthwise direction perpendicular to the longitudinal direction and a fifth heat generating element provided in the other end portion of the heater with respect to the widthwise direction, and
wherein with respect to the widthwise direction, the fourth heat generating element, the third heat generating element, the second heat generating element and the fifth heat generating element are arranged in a named order.

14. An image forming apparatus according to claim 13, further comprising:
a first contact to which one end portion of each of the fourth heat generating element and the fifth heat generating element is electrically connected;
a second contact to which the other end portion of each of the third heat generating element, the fourth heat generating element, and the fifth heat generating element is electrically connected;
a third contact to which one end portion of each of the second heat generating element and the third heat generating element is electrically connected;
a fourth contact to which the other end portion of the second heat generating element is electrically connected;
a first connecting unit configured to be connected between the first contact and the second contact and switched in state to a connection state in which the first contact and the second contact are electrically connected and a non-connection state in which the first contact and the second contact are electrically disconnected; and
a second connecting unit configured to be connected between the third contact and the fourth contact and switched in state to a connection state in which the third contact and the fourth contact are electrically connected and a non-connection state in which the third contact and the fourth contact are electrically is connected,
wherein the controller performs control so that the fourth heat generating element and the fifth heat generating element are caused to generate heat by putting the first connecting unit and the second connecting unit in the connection state and the non-connection state, respectively, and so that the second heat generating element is caused to generate heat by putting the first connecting unit and the second connecting unit in the non-connection state and the connection state, respectively.

15. An image forming apparatus according to claim 14, further comprising a switching unit configured to be switched to a state in which the second contact and the third contact are electrically connected and a state in which the third contact and the fourth contact are electrically connected,
wherein when the controller performs control so that the second heat generating element is caused to generate heat, the controller performs control so as to switch the switching unit so that the state in which the third contact and the fourth contact are electrically connected is formed.

16. An image forming apparatus according to claim 13, wherein the second heat generating element and the third heat generating element are disposed so as to be symmetrical with respect to the widthwise direction.

17. An image forming apparatus according to claim 1, further comprising:
a first rotatable member configured to be heated by the heater; and
a second rotatable member configured to form a nip in cooperation with the first rotatable member.

18. An image forming apparatus according to claim 17, wherein the first rotatable member is a film.

19. An image forming apparatus according to claim 18, wherein the heater is provided in an inside space of the film, and
wherein the nip is formed by the heater and the second rotatable member through the film.

20. An image forming apparatus according to claim 1, further comprising an image forming unit configured to form an unfixed toner image on a recording material,
wherein the fixing device fixes the unfixed toner image on the recording material.
